(19) United States
(12) Patent Application Publication
(10) Pub. No.: US 2008/0281752 A1
(43) Pub. Date: Nov. 13, 2008

(54) ONE-PRICE HOME MORTGAGE LENDING METHOD AND PLATFORM

(76) Inventor: Yung-Sung CHIEN, Taipei (TW)

Correspondence Address: SINORICA, LLC, 528 FALLSGROVE DRIVE, ROCKVILLE, MD, 20850, US

(21) Appl. No.: 12/032,932

(22) Filed: Feb. 18, 2008

(30) Foreign Application Priority Data
May 11, 2007 (TW) 096116746
Nov. 14, 2007 (TW) 096142987

(51) Int. Cl. G06Q 40/00

(52) U.S. Cl. 705/38

(57) ABSTRACT

A method and platform for an online one-price home mortgage lending is disclosed. House buyers use the platform to obtain a mortgage with autonomous interest rates. The platform provides a loan to members to allow them to get their house in advance or to pay off an existing home mortgage. After receiving the loan members participate in an auction process. The bid-winner receives the funds and repays the loan in installments. Non bid-winners are issued a transferable auction certificate and wait until the next term to bid again.

### BACKGROUND OF THE INVENTION

1. Field of the Invention

The present invention relates to financial systems. More specifically, the present invention discloses a method and platform for providing online one-price home mortgage loans using an auction.

2. Description of the Prior Art

Home loans are typically acquired from traditional banking institutions and are one of a bank's core businesses. However, financial institutions must perform asset/liability management by trying to match the maturity of their deposits with the length of their loan commitments. This is done to avoid being adversely affected by changes in interest rates. Banks make loans at interest rates that differ from interest rates paid on deposits. For example, a typical mortgage loan is repaid over 20 years compared with a term deposit of 1 to 3 years. Since deposits usually have shorter maturity than loans there is often a mismatch between assets (loans) and liabilities (deposits). This is called the asset/liability gap.

Banks are subject to short-run variations on short-term deposits and are expected to earn profits through long-term mortgage loans. They provide floating rate loans to shift the interest rate risk to mortgage clients. Because of this mortgage clients are not able to estimate the total interest payments.

To solve this problem many insightful bankers are looking for creative ways to remedy the current situation. “Interactive mortgage and loan information and real-time trading system”—U.S. Pat. No. 5,995,947, provides a method for lenders to place an offer and asks borrowers to choose the right lender. Loan providers could be individuals or financial institutions. However, since the loan period is long it is very difficult for an individual to act as a loan provider due to the lack of liquidity. Also, if the funds provider is a financial institution the interest rate differential still exists.

“System and method for implementing a mortgage plan”—U.S. Pat. No. 6,904,414 provides an accelerated principal amortization mechanism in which lenders may share the benefit from the possible increase in future house prices. The lenders expect the price of housing will increase. The patent considers folding the rising house prices into the mortgage. Typically, this is good for borrowers since they can get a cheaper loan. However, this method is not advantageous for lenders since they still bear higher interest-rate risk while house prices keep falling and interest rates rise.

Therefore there is need for a more effective method of providing lending and borrowing opportunities for fixed rate loans.

### SUMMARY OF THE INVENTION

To achieve these and other advantages and in order to overcome the disadvantages of the conventional method in accordance with the purpose of the invention as embodied and broadly described herein, the present invention provides a method for a one-price home mortgage lending platform.

The present invention responds to a direct Internet-based lending mechanism using Internet technology. In the method and platform there is no substantial distance and friction between the mortgage clients and the deposit clients. The lending funds, which are determined by auction, can be directly supplied by house buyers in order to respond to the intensity of individual demand under the mechanism of combining depositing and lending operations.

In order to achieve said purpose the present invention provides Internet technologies and a data processing facility. Members employ wired or wireless devices such as a computer, a PDA, a notebook computer, or a mobile phone to connect to the platform server and initiate the auction and capital appropriation process. Via the database the platform analyzes supply and demand of capital market funding, set a reasonable interest rate, carry out a house appraisal, analyze a loan amount, calculate cash flow of auction funds in the platform, and prepare an auction certificate.

The method for the one-price home mortgage lending platform of the present invention provides for a direct online encounter opportunity between mortgagers and depositors. The lending funds can be directly supplied by the house buyers. Banks in its role are not only fiscal agents for earning the interest rate differential, but also are new agents for providing the financial platform to charge a handling fee and a guarantee fee. Banks without funds-pressure can manage the mortgage and help customers achieve their long-term financial benefit with one-price mortgage lending. This solves the plight of their business operations, which employ an Asset/Liability Gap.

The method and platform of the present invention applies a concept of direct finance to include a form of funding bargain platform into the mortgage business. One of the characteristics of the platform is, via the mechanism of combining savings and lending operations, to make consumers combine banking funds and personal savings for purchasing a house. Therefore, this platform can assist banks to solve the plight of business operations with the short-term deposit assistance to long-term loans.

Another characteristic of the platform is the relationship between members and platform providers. Lending platform providers provide a one-to-one auction to members, so the offers can go back and forth until both parties have agreed. Therefore, this platform provides an affordable loan to members, and it is a custom-based loan product based on members' economic ability.

Another characteristic of the platform is that the bid-winner will pay a fixed amount each term for the rest of the period. This platform provides members with home loan products without interest rate risk. It can better protect consumers while the long-term home loan markets still carry variable interest rates.

Since the platform utilizes Internet technologies to meet the needs of both lenders and borrowers, transaction costs are reduced and both sides benefit. Therefore, this platform not only provides more favorable interest rates to mortgage members, but also provides superior interest rates for term deposits exclusive to deposit members.

The method of the present invention provides an exit mechanism for platform participants. Members according to their personal requirements can transfer their auction certificates, thus they can use funds in more flexible way.

Currently, home loans provided by banks have a high level of homogeneity, and most do not satisfy customer demand. Due to banks applying short-term liquidity assistance to long-term loans, interest rate change is unpredictable and most home loan products today offer floating rate loan and then enhance the default risk. Therefore, uncertainty of repayment may arise. In fact, when interest rates increase substantially, it presents bankruptcy risk to banks. The method and platform of the present invention not only changes the phenomenon of short-term cash inflow (deposits) to long-term cash outflow (loans) and the earning of interest-rate differential, but also provides a custom-based product with one-price repayment plan. Both the borrower and depositor sides can receive a loan that is superior to current market conditions. There is an obvious different market segment and superiority when comparing the present invention with other loan products.

An objective of the present invention is to combine the home loan and the direct financial platform. Members, according to their house-purchasing plan, choose to deposit on the platform or apply directly for a home loan. Borrowers who already have mortgages can refinance their homes using this platform. After a member enters into the platform to place bids, the bid-winner will pay a fixed amount each term which prevents interest rate risk.

Another objective of the present invention is to employ a method of combining savings and lending operations in order to collect funds. Both banks and clients can undertake lending funds together. The risk of capital cost which is undertaken by banks and clients can be reduced, and the plight of the Asset/Liability Gap can be gradually solved. The interest-rate differentials are replaced by commission fees.

Another objective of the present invention is to provide a funding platform with integrated savings and borrowing function for members who are ready to purchase a house. As a tool for accumulating funds for a down payment on a house, it can obtain a favorable interest rate. The platform provides procedures including a deposit preparation before purchasing the house and has a future fixed amount payment plan. Therefore, it is a linear-type home loan that is different from a conventional point-type mortgage loan. A linear-type loan comprises multiple deposits prior to the actual loan. For example, a member can make 5 deposits before becoming the bid-winner and receiving the loan. In contrast the conventional loan is considered a point-type loan since the loan is received upon approval of the loan application.

An objective of the present invention is to provide members a custom-based repayment plan. Members can continue to offer a bid until they obtain a better interest rate than other home loans.

This home loan product includes an integrated deposit and lending mechanism. Banks not only can attract loan clients, but also can attract clients who are depositors. This increases client loyalty and increases bank business.

The mortgage lending method and platform has a function integrating saving and lending. It not only provides lending funds to clients, but also provides better financial and management services to clients. This increases the opportunity for selling other financial products. For example, in addition to a home mortgage loan the platform operator can offer other financial products such as insurance, funds, etc. to members.

The present invention employs a securitization function. The platform issues an auction certificate according to a member's own auction privilege. A member can also transfer their auction certificates and opt to begin early exit transactions according to their needs and the variation in an anticipated capital. The flexible use of funds increases the willingness to participate in platform transactions.

In order to achieve the abovementioned objects, the present invention provides a one-price mortgage lending platform. The platform comprises a server that couples to users via the Internet or a private network. Users connect to the server which provides a dedicated webpage.

A membership auditing and login process is provided. A user becomes a member by inputting all basic information, applying for an application audit, and receiving membership approval. The member enters the platform web server, logs into his/her account and types his/her password. The system proceeds with the authentication and completes the login procedure.

A mortgage lending application process is also provided. Members choose to directly deposit funds or apply for a home loan. If a member chooses to directly deposit funds they become a deposit member. If they choose to apply for a home loan they become a home loan member. A home loan member applies for an appraisal first, and then organizes the home loan structure. If the member does not agree to said structure, then he/she becomes a deposit member. If the member agrees to said structure, then he/she signs the contract and creates a mortgage to his/her house. After the process has been completed, the member receives the loan. The lending platform directly remits funds to the seller or to the original institution.

The present invention further provides an auction process. According to the loan amount and loan term, the member can either make an offer in a built-in platform, or choose not to make an offer and become a depositor. The member who wants to make an offer inputs a bid price. If the platform accepts the offer, then the member who wins the bid becomes a borrower. If the platform does not accept the offer, the member can decide whether or not to continue to make an offer. If the member decides not to make an offer, then the bidding transaction is closed and the member becomes a depositor. If the member decides to make an offer again, they reset the bid price.

A clearing and delivering process is also provided. A depositor via the platform clears his due payments and makes his payment payable to the platform in order to complete the transaction. A borrower via the platform clears his/her receivable and the platform remits its receivable to the borrower for completing the transaction.

The present invention also provides an operation process for auction certificates of a home loan. After a deposit member has remitted payment into the platform and completes his transaction, the platform calculates total payment and issues an auction certificate to the member. The member decides whether or not to trade his/her auction certificate. If the answer is no, the platform will deposit the member's auction certificate into a custody institution. If the answer is yes, the member performs a transfer transaction for the auction certificate on the platform.

The one-price home mortgage lending platform of the present invention comprises a server. Members can employ Internet technologies, a wire/wireless communication device, or local area networks to link to the user interface of the server. Members exchange information securely with the server in real time. Members perform their identification audit, home loan application, auction trading, clearing and transaction delivering by interacting with the server. The platform also stores the abovementioned data into the database, and records results and updates data.

The server employs a member identification auditing module to process applicant's personal information in order to determine an applicant's eligibility. This data is stored in a database and retrieved to verify a member's login information.

The server also employs a house appraisal module to process a member's basic house information and appraisal results. This information is stored in the database. The loan amount auditing module or the loan structure organization module can retrieve said information to use as the basis for calculations.

A loan amount auditing module is provided to allow the server to estimate the loan amount which is then stored in the database files.

The server employs a home loan structure organization module to analyze the composition structure of total loan amount. This structure means a mortgage loan, a credit loan and the minimum allowable ratio of down payment to sale price. This information is stored in the database.

The server employs a home loan auction trading module to process a member's auction fund, and operates with the interest rate calculation module to decide whether to accept a member's offer until the member wins the bid or exits the trading.

According to current market interest rates and auction fund interest rates and fund level, the server employs an interest rate calculation module to estimate the current possible number of the bid-winner and the interest rate of the auction fund, and stores the information into the database.

The server employs a clearing and delivering module to carry out clearing and delivering for the bid-winner and the non bid-winners, and stores the information into the database.

A home loan auction certificate module stores the auction certification of the home loan which is approved by the server, and stores data and the results of the auction certificate.

Another advantage of the present invention is that a member can obtain a preliminary loan prior to winning the bid. For example, a member participates by depositing for a number of terms. When the member has enough money for a down payment on a house he/she participates in the auction process. However, the member is not successful and doesn't become the bid-winner for several auctions. Unfortunately, the house the member wants to buy may be sold to another person by the time the member wins the bid. In order to prevent this situation the method of the present invention allows the member to obtain a preliminary loan in order to make the down payment. When the member becomes the bid-winner the member repays this preliminary loan.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a flowchart illustrating a one-price mortgage loan method according to an embodiment of the present invention;

FIG. 2 is a flowchart illustrating an early-stage lending process according to an embodiment of the present invention;

FIG. 3 is a flowchart illustrating implementation of the platform mortgage lending transaction according to an embodiment of the present invention; and

FIG. 4 is a diagram illustrating a one-price mortgage lending platform according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

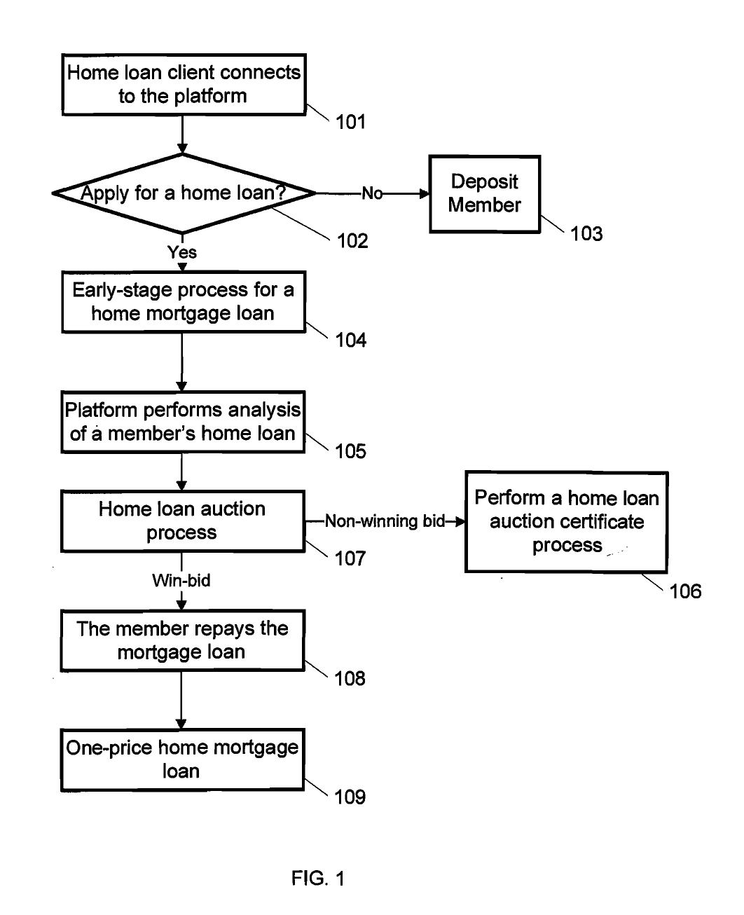

Refer to FIG. 1, which is a flowchart illustrating a one-price mortgage loan method and platform according to an embodiment of the present invention. In the method a mortgage client enters into the one-price mortgage lending platform in Step 101. The mortgage clients include those who wish to buy a house, those who are ready to refinance their mortgage, and those who are ready to buy a house. In Step 102 members choose whether or not they want to apply for a mortgage loan. If the member temporarily has no demand for a mortgage, they become a direct deposit member in Step 103 without applying for the mortgage. If the member has a demand for a mortgage, they enter the platform for an early-stage lending process in Step 104. If the deposit member has a mortgage demand in the future, they can enter into the early-stage lending process to apply for the mortgage. After the early-stage lending operation has finished the loan amount structure module of the platform will process and analyze the mortgage loan, the credit loan and the down payment in order to select the most suitable mortgage program for the member in Step 105. In Step 107 the member initiates a bid on the lending platform. The member can submit a bid price for a current term until the time period to place bids has expired. If the member does not win the bid they will continue to submit bids with escalating bid prices for other opportunities with deposit membership status in Step 106. According to the payable amount after the transaction the platform further calculates, audits, approves and then issues the auction certificate. The member can decide whether to perform the auction certificate transaction. If the member wins the bid, they repay the mortgage loan with the winning bid funds in Step 108, and this fund is used as a member's new loan. As a result, a new home loan is a fixed payment loan and is a one-price mortgage in Step 109. Therefore, the member can eliminate the risk of fluctuating interest rates.

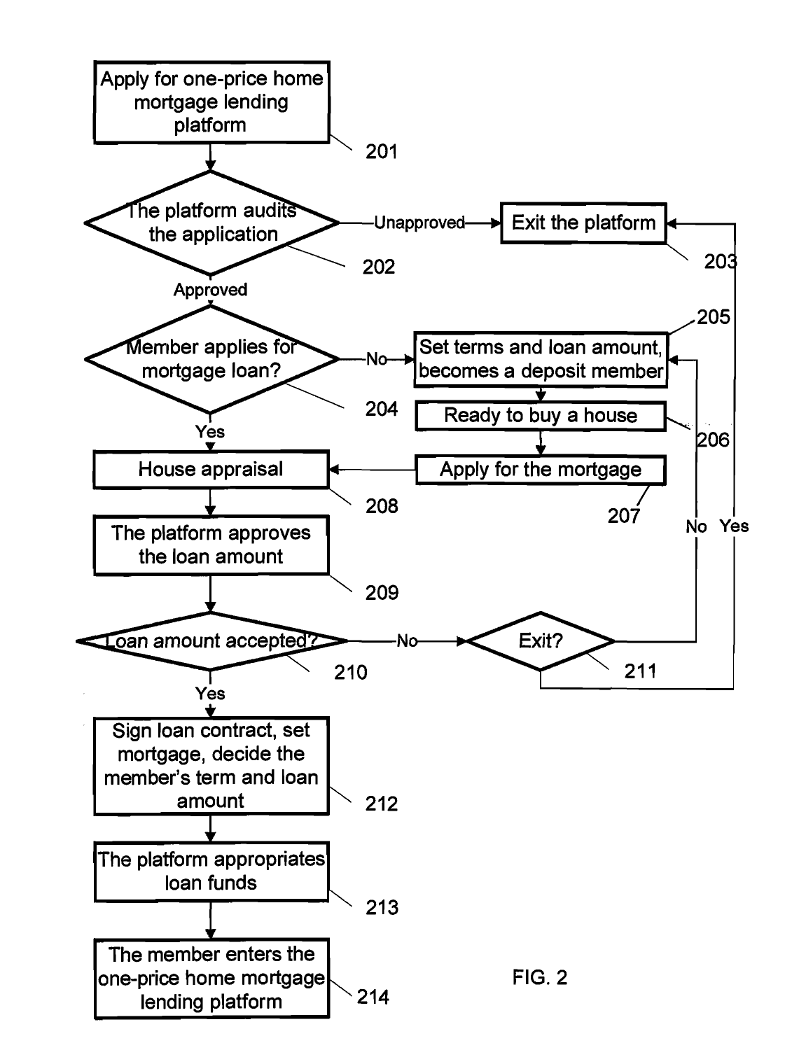

Refer to FIG. 2, which is a flowchart illustrating an early-stage lending process according to an embodiment of the present invention. After the client has applied for a loan using the one-price mortgage lending platform in Step 201, the platform audits the application by reviewing the basic information of the member in Step 202. If the client cannot pass the review, they are not allowed onto the platform and they exit in Step 203. If the member passes the auditing, they then decide whether or not to apply for a mortgage loan in Step 204. If the member decides to continue the loan application process, they ask the house appraisal module to perform a house appraisal in Step 208. The mortgage lending module calculates the loan amount from the appraisal report, and the platform approves a loan based on this loan amount in Step 209. The member according to the loan amount decides whether to receive the approval in Step 210. If the answer is yes, the member signs a mortgage contract with the platform and has their house mortgaged in Step 212. The platform or both sides coordinate the mortgage terms and loan amount. After the contract has been determined, the platform immediately approves and appropriates the funds in Step 213. The loan funds are either remitted directly to the seller from the platform or from the original loan institution. The member then can enter into the one-price home mortgage lending platform in Step 214.

As described above, if the member decides not to apply for the mortgage loan in Step 204, the platform or both sides coordinate to decide the terms and funds amount for participating in the platform and the member becomes the deposit member in Step 205. In Step 206 when the member has a demand for a mortgage they apply for a mortgage using the platform in Step 207. The member and platform then do the steps of house appraisal, signing the contract, mortgaging the member's house. The deposit member then becomes an authorised home loan member.

As shown in FIG. 2, the member can choose whether to accept the approval loan amount in Step 210. If the member chooses to not accept, the member can decide whether to exit the platform in Step 211. If the member exits the platform, then they quit the application in Step 203. If the member does not exit the platform they become a deposit member and return to Step 205. The platform or both sides coordinate to decide the terms and funds amount for participating in the platform.

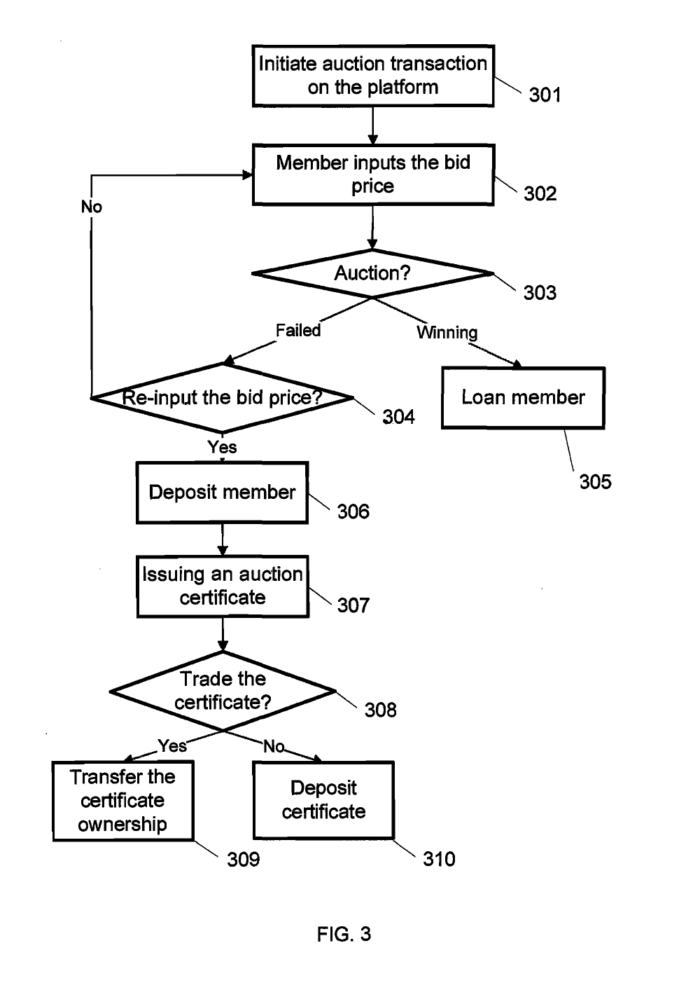

Refer to FIG. 3, which is a flowchart illustrating implementation of the platform mortgage lending transaction according to an embodiment of the present invention. The member who has the auction privilege (the member who has signed the contract and has had their house mortgaged) decides whether or not to submit a bid request. If the member decides to submit the bid in Step 301, they input a bid price in Step 302. The platform according to the input data performs an auction process in Step 303. The bidding price determines the member's lending rate. That is to say the server can select the assessment standard according to the supply and demand of funds, the level of funds of the platform, and the long-short-term interest rate differentials.

If the member wins the bid, the member accepts the bid price as the lending rate and become a loan member in Step 305. The member repays the loan by using the auction funds. This one-price lending feature makes new loans and prevents interest-rate risk. If the member did not win the bid, they can decide whether or not to re-input a bid in Step 304. If the member decides to re-input the bid, then the platform returns to the input bid field in Step 302. If not, then the member remains in deposit member status in Step 306. According to the payable amount of the deposit member, the platform further calculates, audits, approves and issues the auction certificate in Step 307. The member decides whether or not to perform the auction certificate transaction in Step 308. If the member decides to perform an auction certification transaction on the platform, the member then performs the transferring process for the auction certificate in Step 309. If the member does not perform the auction transaction, then they become a deposit member and own an auction certificate in Step 310.

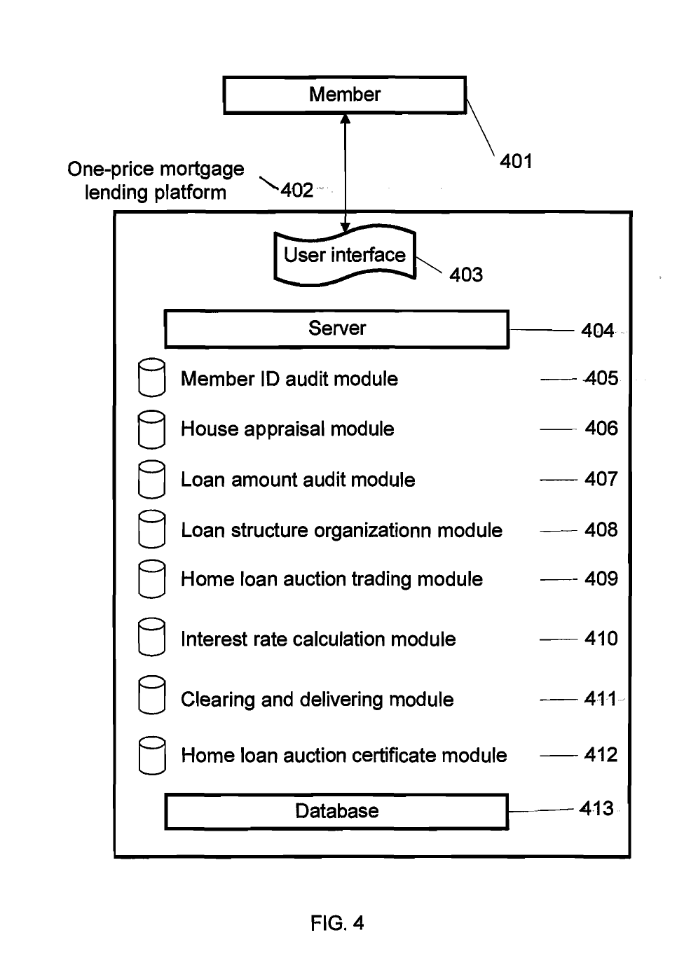

Refer to FIG. 4, which is a diagram illustrating a one-price mortgage lending platform according to an embodiment of the present invention. The platform 402 comprises a server 404, which employs Internet technologies, a wire/wireless communication device, a private or local area network to provide a user interface 403 of the server to the member 401. The server also allows clients with a computer, a mobile phone, or a PDA to link to the platform 402 via the network. The server 404 exchanges information securely in real time with members 401, with a links database 412, and with each module for storing data, information and results into the database 413.

The one-price mortgage lending platform 402 further comprises the following modules:

Member identification auditing module 405: The member identification auditing module 405 has basic information of the clients. It determines whether or not to accept the application. Via the server 404 the member identification auditing module 405 operates, processes, analyzes and executes, and then stores information in the database.

House appraisal module 406: The house appraisal module 406 carries out procedures such as discrimination, analysis, and values determination for the target house. This data is then stored in the database 413.

Loan amount auditing module 407: The loan amount auditing module 407 retrieves analysis data created by the member identification auditing module and the house appraisal module and calculates the loan amount for the target house. This data is then stored in the database 413.

Home loan structure organization module 408: This module 408 helps the member analyze the appraisal report and the loan amount, and it compensates for insufficient funds by using other loans such as, second mortgages and credit loans. In addition, the home loan structure organization module 408 enables the member to know the down payment and total loan amount in order to facilitate decision making about the mortgage.

Home loan auction transaction module 409: This module 409 is used to help a member to get the loan amount and perform the auction process. The home loan auction transaction module 409 creates the auction platform and makes auction fund analysis and decisions.

Interest rate calculation module 410: The interest rate calculation module 410 decides whether or not the bid price is reasonable. The module uses the funds' supply and demand, the funds level of the platform, and the long-short-term interest-rate variation, etc. to decide the acceptable bid price level. If yes, it notifies the server 404 to accept the bid, if no, then it rejects the bid.

Clearing and delivering module 411: The clearing and delivering module 411 clears the bidding result, helps the member to repay the mortgage, and helps members receive the delivering of one-price mortgage lending.

Home loan auction certificate module 412: This module is used to store the auction certificate that is approved by the server 404 and to store the data and result of the auction certificate that the member has used or traded.

Database 413: The database 413 is provided to store the data for the operation, process, analysis, cross examination, and execution of each module for the server 404. Each module and the server 404 can retrieve data from the database 413 in order to operate, process, analyze, cross examine, and execute the corresponding functions.

In the following three examples, an embodiment of a specific implementation of the method of the present invention is applied.

Implementation 1:

Mr. A is an office worker and is married. Mr. A purchased a house a few years ago. He has applied for a home loan at a bank (Bank A). At present, he has an outstanding balance of a mortgage account of around $600,000 with a 15-year repayment term. Due to the increase in interest rate volatility, he decides to apply for a mortgage with the one-price mortgage lending platform in order to reduce the interest rate and avoiding interest-rate variation. First, Mr. A completes the online application procedure and joins the platform. After the platform has reviewed his loan application data, he starts to prepare the pre-approval process, such as estate appraisal, mortgage, decision for auction, and the approval process. After the appraisal, the current value of the house has been assessed at $675,000. According to data provided to the financial institutions that operate the platform, the lender may originate a mortgage loan with a loan-to-value ratio at 80%. Therefore, Mr. A receives a loan of $540,000.

Due to insufficient funds to repay the original amount of the loan, Mr. A needs another $60,000 loan to payoff his $600,000 loan. This loan of $60,000 can be a credit or collateralized loan. After Mr. A has finished the loan application of $60,000, the financial institution provides Mr. A with funds totaling $600,000 ($540,000 of loan funds and additional $60,000) as a preliminary loan so that he can pay off his original loan from Bank A. After the platform has received the liquidation certificate from Bank A and Mr. A has his house mortgaged to the platform for the preliminary loan, Mr. A obtains the credit to attend the auction for loan funds on the platform.

The platform, according to the loan amount and the life span of the house, decides Mr. A's attending duration and funds amount. Alternatively, the client can decide whether or not to attend according to the approval loan amount and the repayment terms. Mr. A wishes to have a 15-year loan and minimal interest rate risk in the future. He decides to attend a $540,000 auction combination for a 15-year term, submitting one bid for each month and the upper limit on the bidding price is set at $3,000.

After Mr. A has attended the funds auction platform, his offer is analyzed by the platform interest-rate calculation module and is accepted by the platform and the transaction is completed. The funds are obtained using the following to calculate:

The Nth term winning-bid funds

An=(U−In)×((N−n))+(U×(n−1)) or Formula 1

$$An = ( U \times ( N - n ) ) + ( U \times ( n - 1 ) ) + {\sum }_{i = 1}^{n - 1} Ii \qquad Formula 2$$

### Wherein

An: Denotes the total amount of the Nth term winning-bid funds
U: Denotes the unit price
N: Denotes the total terms
n: Denotes the current term of bids on the platform
In: Denotes the Nth term bidding price

According to Formula 1, Mr. A offers $100 bid in the first term, the platform via the analysis of the interest-rate calculation module accepts the offer, and then Mr. A can obtain

($3,000−$100)×(180−1)+$3,000×(1−1)=$519,100

Therefore the auction fund of $519,100 obtained from the auction platform is requested to repay the outstanding $540,000 mortgage loan. Since the funds of the mortgage lending platform are determined using an auction mechanism, the amount of the auction fund has an uncertainty. The funds obtained from the auction process may not be sufficient to reimburse the total loan amount. Thus, the outstanding loan still has $20,900 left due after the existing loan is paid. Therefore, a short term credit loan is needed in order to fully repay the debt.

After Mr. A receives the winning bid for $519,100 to partially repay his loan, he must repay $3,000 monthly with the platform during the existing period (this case has 179 terms). During the auction process using the platform and payoff process for the mortgage loan helps clients to refinance their loan. The original mortgage that had a floating interest rate is converted to a fixed interest rate mortgage and a one-price home mortgage lending system is achieved.

The forgoing implementation can be applied to refinancing a home mortgage, securing a loan for a new house buyer, and liquidating a preliminary loan.

Implementation 2:

Mr. B just graduated from school and has a new job. In order to avoid excessive consumption and to better plan for the future, he decides to save money for buying a house. Since Mr. B just graduated and is not urgent for having a house, he is still not able to pay for the down payment. In addition, most banks only offer a low deposit interest rate which cannot satisfy him for a forced savings plan on a future housing demand. After he learned of the one-price mortgage lending platform of the present invention, Mr. Be knew this project could help satisfy his savings and housing purchase plan. He then decides to submit an application to this financial institution platform.

Mr. B applies to join the one-price mortgage lending platform. He passes the platform review and become a formal member. After he has completed his registration and an audit process for qualification, the platform inquires whether Mr. B wants a mortgage loan. Since currently Mr. B has no ability to buy a house, he decides not to apply for a loan until he saves enough money for the down payment. According to Mr. B's self-analysis he decides to spend about $500,000 to buy a house. According to market practices he needs to make a down payment of at least 20 percent of a home's purchase price to get a home loan. Therefore, he can get ready to buy a house when his savings reach $100,000. After Mr. B decides to attend an auction combination with a 20-year term, submitting one bid for each month with the upper limit on the bidding price set at $2,000 (i.e. the scale of the auction combination is $2,000×240=$480,000), and obtains an auction certificate which identifies his ownership of the total deposits on the platform and shows his privilege to attend the auction for mortgage lending on the platform in the future.

Time passes and the down payment has accumulated $100,000 at the 50^{th} term. (here we ignore the basic bidding price provided by the platform, even if the platform provides it, there is not much difference with the actual deposit amount). Due to Mr. B reaching his necessary down payment he starts to search for a house. After a two months search, Mr. B decides to buy a house for $550,000. Since Mr. B doesn't have enough money to buy a $550,000 house, he applies for a mortgage loan on the platform to cover the payment demand for the house. If the appraisal says the house is worth $600,000, according to the data provided to the financial institution responsible for operating the platform, the lender may originate a mortgage loan with a loan-to-value ratio at 80%. Therefore, Mr. B was approved a loan of $480,000. If Mr. B agrees to accept the appraisal he accepts this $480,000 loan. However, there is still a shortage of $70,000 between the $480,000 loan and $550,000 house cost. The platform via the member lending organization structure analysis gives another $70,000 credit loan to pay the seller. Mr. B may need to provide further collateral depending on his credit status to receive the credit loan.

This loan is basically similar to a conventional loan, and is amortized with a variable rate structure which cannot prevent exposure to interest rate risk. For this reason, Mr. B will then attend the auction to receive an affordable and fixed-payment mortgage loan. Assuming Mr. B offers a bid at $100 at the 54^{th} term the platform accepts the offer via the analysis of the interest-rate calculation module. According to the abovementioned formula 1, Mr. B can obtain

($2,000−$100)×(240−54)+$2,000×(541−1)=$459,400

After Mr. B obtains the loan funds, similarly to the implementation 1, high priority is given to reimburse the $480,000 loan. Since the amount of the auction fund has an uncertainty, the funds obtained from the auction process cannot be used to reimburse the total loan amount. Thus, the loan still has $20,600 outstanding after the existing loan is paid off. Similarly, after Mr. B pays off his partial loan, he must repay $2,000 monthly during the remaining terms for future combinations. As a result, Mr. B enjoys the advantages of the one-price mortgage lending platform.

Implement 3:

Mr. C is a middle level manager in a business firm and he owns a house that has had the mortgage paid off. Since the present house does not satisfy his family's needs he contacts the platform with the intention of accumulating funds for purchasing a house. He estimates his existing house value is $600,000. This plus $200,000 in personal savings, he will still need an additional $700,000 to buy a $1,500,000 house. After self-analysis, he decides to accept a mortgage loan with 240 terms and a $3,000 upper bidding limit. Until the 33 ^{rd} term, his deposit fund is over $85,000. However, Mr. C receives a notice telling him his company is relocated him abroad. He must abandon his original plans for the house. Since the platform will issue an auction certificate to non bid-winners (in virtual or real form), it discloses their future auction privileges and allows members to transfer the certificates or use the certificates for mortgages.

At this time Mr. C can, via the auction transaction mechanism provided by the platform, make a transfer transaction for the auction certificate. Meanwhile, Mr. D via the auction transaction offers $92,000 to buy the auction certificate. If Mr. C sells his auction certificate, not only can he earn part of interest benefit of $7,000 ($92,000−$85,000), but he can smoothly exit the trading combination. And Mr. D, by obtaining the auction certificate directly attends a fund auction combination which has 207 terms of $3,000 each term, earns his interest income in order to deal with the demand of the housing fund.

An object of the one-price mortgage lending platform is to provide members with direct on-line contact opportunities. This is different from other types of mortgages and means the financial institutions can charge a commission fee to the platform clients as remuneration for using platform services. The mortgage loan, which is provided by the platform, is basically a form of financing. The core value of the existing platform is the ability to provide funds with auction opportunities, and the commission fee is the main benefit source. This mechanism allows the financial institution to convert into a financial supplying service provider by implementing the spirit of direct finance.

In an embodiment of the present invention the platform and members utilize a private network to interact. Since the server is on a private network the platform has increased security.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for an online one-price home mortgage lending platform comprising:
providing a user interface to allow a user to interact with the platform;
receiving a loan application from the user;
analyzing financial data regarding the user;
receiving bid prices from users for a loan with a fixed period of time for repayment;
determining a bid-winner; and
providing the loan to the bid-winner.

2. The method for an online one-price home mortgage lending platform of claim 1, the bid-winner repaying the loan in installments.

3. The method for an online one-price home mortgage lending platform of claim 1, further comprising:
determining whether or not the user wants to apply for a loan.

4. The method for an online one-price home mortgage lending platform of claim 3, wherein if the user doesn't want to apply for a loan the user is considered a deposit member.

5. The method for an online one-price home mortgage lending platform of claim 1, further comprising:
performing an appraisal of a house; and
notifying the user of results of the appraisal.

6. The method for an online one-price home mortgage lending platform of claim 5, further comprising:
using the appraisal to determine amount of the loan.

7. The method for an online one-price home mortgage lending platform of claim 6, further comprising:
setting up a mortgage loan agreement to confirm loan amount and terms.

8. The method for an online one-price home mortgage lending platform of claim 5, further comprising:
verifying the appraisal is greater than an existing home mortgage loan.

9. The method for an online one-price home mortgage lending platform of claim 1, where users continue to submit escalating bid prices until the bid-winner is determined.

10. The method for an online one-price home mortgage lending platform of claim 9, further comprising:
issuing a home loan auction certificate to all non bid-winners.

11. The method for an online one-price home mortgage lending platform of claim 10, where ownership of the home loan auction certificate is transferable.

12. A method for an online one-price home mortgage lending platform comprising:
providing a user interface to allow a user to interact with the platform;
receiving a loan application from the user;
analyzing financial data regarding the user;
receiving bid prices from users for a loan with a fixed period of time for repayment;
determining a bid-winner;
providing the loan to the bid-winner; and
accepting repayment from the bid-winner.

13. The method for an online one-price home mortgage lending platform of claim 12, where all non bid-winners wait to bid until another auction.

14. The method for an online one-price home mortgage lending platform of claim 12, where the bid-winner is not allowed to bid again after winning.

15. The method for an online one-price home mortgage lending platform of claim 12, further comprising:
issuing a home loan auction certificate to all non bid-winners.

16. The method for an online one-price home mortgage lending platform of claim 15, where ownership of the home loan auction certificate is transferable.

17. An online one-price home mortgage lending platform comprising:
a server comprising a user interface and a database, the server further comprising:
a member identification auditing module for temporarily storing a user's personal information in order to verify a user;
a house appraisal module for appraising a house value and storing the appraisal results;
a loan amount auditing module for retrieving membership qualification data and the appraisal results;
a home loan auction transaction module for carrying out a home loan auction transaction on the platform;
a home loan auction certificate module for transferring ownership of an auction certificate;
a clearing and delivering module for clearing and delivering member accounts based on whether or not payment has been remitted;
a home loan structure organization module for analyzing and comparing difference between an appraisal results and a loan amount; and
an interest rate calculation module for calculating whether or not auction funds correspond to supply and demand of funds.

18. The online one-price home mortgage lending platform of claim 17, wherein if the user doesn't want to apply for a loan the user is considered a deposit member.

19. The online one-price home mortgage lending platform of claim 17, wherein a home loan auction certificate is issued to all non-winners of the home loan auction.

20. The online one-price home mortgage lending platform of claim 19, where ownership of the home loan auction certificate is transferable.
